(19) United States
(12) Patent Application Publication
(10) Pub. No.: US 2017/0078201 A1
(43) Pub. Date: Mar. 16, 2017

(54) TERMINAL APPARATUS, COMMUNICATION SYSTEM, SERVER, COMMUNICATION METHOD, AND STORAGE MEDIUM STORING PROGRAM

(71) Applicant: NEC Corporation, Minato-ku, Tokyo (JP)

(72) Inventor: Eiji TAKAHASHI, Tokyo (JP)

(73) Assignee: NEC Corporation, Minato-ku, Tokyo (JP)

(21) Appl. No.: 15/123,354

(22) PCT Filed: Feb. 18, 2015
(86) PCT No.: PCT/JP2015/000737

§ 371 Date: Sep. 2, 2016

(30) Foreign Application Priority Data
Mar. 20, 2014 (JP) 2014-058494

(51) Int. Cl. H04L 12/801; H04W 28/02; H04L 12/851

(52) U.S. Cl. CPC H04L 47/11; H04L 47/24; H04W 28/0284

(57) ABSTRACT

In order to execute data communication more efficiently, a communication system 1000 of the present invention includes a server 100 and a terminal apparatus 200 that executes data communication with the server 100. The server 100 generates a request signal on the basis of a first congestion degree of the data communication and transmits the generated request signal to the terminal apparatus 200, and the mobile terminal 200 executes data communication with the server 100 on the basis of the received request signal.

### TECHNICAL FIELD

The present invention relates to a terminal apparatus, a communication system, a server, a communication method, and a storage medium storing a program.

### BACKGROUND ART

A wide variety of data communications such as browsing of Web sites, transmission/reception of streaming videos, transmission/reception of electronic mail, transmission/reception of electronic files, and the like are being executed using communication terminals. Therefore, data traffic is increasing. This makes it desirable to efficiently execute data communication. Specifically, it is desirable to execute transmission/reception of non-real-time data which is not required to be transmitted/received in real-time between communication terminals and a server when there is no congestion of communication.

In relation to the above, PTL 1 discloses a technique of a radio terminal in which gap communication is attempted at every cycle of a waiting time and communication is continued or interrupted until a next cycle in accordance with a congestion degree of communication.

### CITATION LIST

### Patent Literature

[PTL 1] Japanese Laid-open Patent Publication No. 2012-165107

### SUMMARY OF INVENTION

### Technical Problem

However, in the technique described in PTL 1, when communication is interrupted, it is difficult to start, even when, for example, a congestion degree of communication calculated on the basis of a data communication amount per unit time or the like decreases thereafter, next communication until a waiting time passes. Therefore, in a situation where a congestion degree of communication varies at a cycle shorter than a waiting time, there is a problem that it is difficult to efficiently execute data communication with a server or the like.

In the technique described in PTL 1, when a relatively short waiting time is set, a following capability for variations of a congestion degree of communication increases, but communication attempts are frequently repeated even in a situation where communication continues to congest, and therefore communication congestion is promoted. On the other hand, when a relatively long waiting time is set and communication is interrupted, it is difficult to start, even when a congestion degree of communication decreases thereafter, next communication until a waiting time passes. Therefore, there is also a problem that it is difficult to set a waiting time.

In view of such circumstances, the present invention has been made, and an object of the present invention is to provide a communication system and the like capable of executing data communication more efficiently.

### Solution to Problem

A communication system of the present invention includes a server and a terminal apparatus that executes data communication with the server, wherein the server includes a server side congestion degree calculation means configured to calculate a first congestion degree of the data communication executed with the terminal apparatus, a request signal generation means configured to generate a request signal that is a signal for making a request of the data communication to the terminal apparatus on the basis of the first congestion degree calculated by the server side congestion degree calculation means, and a request signal transmission means configured to transmit the request signal generated by the request signal generation means to the terminal apparatus; the terminal apparatus includes a terminal side data communication means configured to execute the data communication with the server and a request signal reception means configured to receive the request signal transmitted by the request signal transmission means; and the terminal side data communication means executes the data communication with the server on the basis of the request signal received by the request signal reception means.

Further, a communication method of the present invention is a communication method performed between a server and a terminal apparatus that executes data communication with the server, wherein the server calculates a first congestion degree of the data communication executed with the terminal apparatus, generates a request signal that is a signal for making a request of the data communication to the terminal apparatus on the basis of the calculated first congestion degree, and transmits the generated request signal to the terminal apparatus; and the terminal apparatus receives the request signal transmitted by the server and executes the data communication with the server on the basis of the received request signal.

Further, a storage medium storing a program of the present invention is a storage medium storing a program used in a system including a server and a terminal apparatus that executes data communication with the server, the program causing a computer to execute: server side congestion degree calculation processing, performed by a server, for calculating a first congestion degree of the data communication executed with the terminal apparatus; request signal generation processing, performed by a server, for generating a request signal that is a signal for making a request of the data communication to the terminal apparatus on the basis of the first congestion degree calculated by the server side congestion degree calculation processing; request signal transmission processing, performed by a server, for transmitting the request signal generated by the request signal generation processing to the terminal apparatus; request signal reception processing, performed by the terminal apparatus, for receiving the request signal transmitted by the request signal transmission processing; and data communication execution processing, performed by the terminal apparatus, for executing the data communication with the server on the basis of the request signal received by the request signal reception processing.

Further, a terminal apparatus of the present invention includes a terminal side data communication means configured to execute data communication with a server and a request signal reception means configured to receive, from the server, a request signal for making a request of the data communication to the terminal apparatus by the server, wherein the terminal side data communication means executes the data communication with the server on the basis of the request signal of the data communication received by the request signal reception means.

Further, a server of the present invention includes a server side congestion degree calculation means configured to calculate a first congestion degree of data communication executed with a terminal apparatus, a request signal generation means configured to generate a request signal that is a signal for making a request of the data communication to the terminal apparatus on the basis of the first congestion degree calculated by the server side congestion degree calculation means, and a request signal transmission means configured to transmit the request signal generated by the request signal generation means to the terminal apparatus.

### Advantageous Effects of Invention

According to the present invention, data communication can be executed more efficiently.

### BRIEF DESCRIPTION OF DRAWINGS

FIG. 1 is a block diagram illustrating a configuration of a communication system in a first exemplary embodiment of the present invention.

FIG. 2 is a diagram illustrating an operation flow of the communication system in the first exemplary embodiment of the present invention.

FIG. 3 is a block diagram illustrating a configuration of a communication system in a second exemplary embodiment of the present invention.

FIG. 4 is a diagram illustrating an operation flow in which a terminal apparatus of the communication system in the second exemplary embodiment of the present invention executes data communication with a server at a predetermined cycle.

FIG. 5 is a diagram illustrating an operation flow at the time when the terminal apparatus of the communication system in the second exemplary embodiment of the present invention has received a request signal.

FIG. 6 is a block diagram illustrating a configuration of a communication system in a third exemplary embodiment of the present invention.

FIG. 7 is a diagram illustrating an operation flow of the communication system in the third exemplary embodiment of the present invention.

FIG. 8 is a block diagram illustrating a configuration of a communication system in a fourth exemplary embodiment of the present invention.

### DESCRIPTION OF EMBODIMENTS

### First Exemplary Embodiment

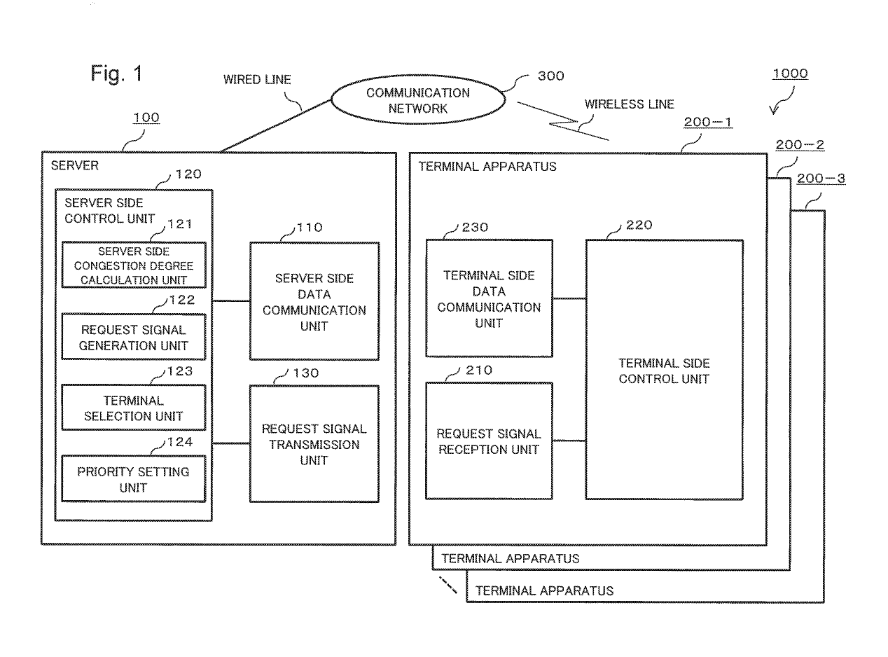

Using FIG. 1, a detailed configuration of a communication system 1000 in a first exemplary embodiment of the present invention will be described. FIG. 1 is a block diagram illustrating a configuration of the communication system 1000.

As illustrated in FIG. 1, the communication system 1000 includes a server 100 and a plurality of terminal apparatuses 200-1, 200-2, and 200-3. In the following description, when it is not specifically necessary to discriminate and describe each of the plurality of terminal apparatuses 200-1, 200-2, and 200-3, these terminal apparatuses will be collectively referred to as a terminal apparatus 200.

First, using FIG. 1, a detailed configuration of the server 100 will be described.

As illustrated in FIG. 1, the server 100 includes a server side data communication unit 110, a server side control unit 120, and a request signal transmission unit 130.

The server 100 is connected to a communication network 300 via a wired line. The server 100 may be wirelessly connected to the communication network 300. Further, the server 100 is connected to the terminal apparatus 200 via the communication network 300. The server 100 mutually executes data communication with the terminal apparatus 200 via the communication network 300.

As illustrated in FIG. 1, the server side data communication unit 110 is connected to the server side control unit 120. The server side data communication unit 110 mutually executes data communication with a terminal side data communication unit 230 of the terminal apparatus 200 via the communication network 300.

Specifically, the server side data communication unit 110 transmits data to the terminal side data communication unit 230 of the terminal apparatus 200 via the communication network 300.

Further, the server side data communication unit 110 receives data transmitted from the terminal side data communication unit 230 of the terminal apparatus 200 via the communication network 300.

The server side data communication unit 110 receives information on a communication quality in the terminal apparatus 200 from the terminal apparatus 200. The information on a communication quality includes information such as an RSSI (Received Signal Strength Indicator), an RSRP (Reference Signal Received Power), an RSRQ (Reference Signal Received Quality), an SINR (Signal-to-Interference plus Noise-Ratio), and the like, for example.

As illustrated in FIG. 1, the server side control unit 120 is connected to the server side data communication unit 110 and the request signal transmission unit 130. The server side control unit 120 controls the entirety of the server 100.

Further, the server side control unit 120 receives various types of pieces of information (e.g. a data size and a communication time) and the like in data transmitted/received by the server side data communication unit 110. Further, the server side control unit 120 outputs a request signal generated by a request signal generation unit 122 and a selection result of a terminal selection unit 123 to the request signal transmission unit 130.

The server side control unit 120 includes a server side congestion degree calculation unit 121, a request signal generation unit 122, a terminal selection unit 123, and a priority setting unit 124.

The server side congestion degree calculation unit 121 calculates a first congestion degree of data communication executed with the terminal apparatus 200. The server side congestion degree calculation unit 121 calculates a first congestion degree of data communication at every predetermined cycle (e.g. 30 seconds).

The first congestion degree of data communication refers to a congestion degree calculated on the server 100 side. More specifically, the first congestion degree of data communication is information such as a congestion degree of data communication used when the request signal generation unit 122, to be described later, determines whether to generate a request signal, a utilization rate of radio resources shared by the terminal apparatus 200, and the like.

Herein, the server side congestion degree calculation unit 121 calculates a first congestion degree of data communication on the basis of a throughput of data communication executed with the terminal apparatus 200. A specific method in which the server side congestion degree calculation unit 121 calculates a first congestion degree of data communication will be described later.

The server side congestion degree calculation unit 121 may calculate a first congestion degree on the basis of information on a communication quality in the terminal apparatus 200 as described above.

Further, the server side congestion degree calculation unit 121 may inspect traffic information passing through the communication network 300 using DPI (Deep Packet Inspection) and calculate a first congestion degree on the basis of the traffic information. The traffic information refers to information such as a total throughput value of the terminal apparatuses 200-1, 200-2, and 200-3 and the like, for example.

The request signal generation unit 122 generates a request signal that is a signal for making a request of data communication to the terminal apparatus 200 on the basis of the first congestion degree of data communication calculated by the server side congestion degree calculation unit 121.

The terminal selection unit 123 selects a terminal apparatus to be a transmission destination of the request signal generated by the request signal generation unit 122 among the terminal apparatuses 200 on the basis of a priority set by the priority setting unit 124 to be described later.

The terminal selection unit 123 is a unit for selecting a terminal apparatus to be a transmission destination of a request signal among the terminal apparatuses 200. Therefore, when, for example, there is one terminal apparatus (e.g. only the terminal apparatus 200-1), the terminal selection unit 123 is not always needed in the present exemplary embodiment. A specific method in which the terminal selection unit 123 selects a terminal apparatus to be a transmission destination will be described later.

The priority setting unit 124 sets a priority of each of the terminal apparatuses 200. The priority refers to information such as a priority order, a priority degree, or the like used when the terminal selection unit 123 selects a terminal apparatus to be a transmission destination of a request signal.

The priority setting unit 124 is a unit for setting a priority that is information for the terminal selection unit 123 to select a terminal apparatus to be a transmission destination of a request signal among the terminal apparatuses 200. Therefore, in the same manner, when there is one terminal apparatus, the priority setting unit 124 is not always needed in the present exemplary embodiment. A specific method in which the priority setting unit 124 sets a priority of each of the terminal apparatuses 200 will be described later.

As illustrated in FIG. 1, the request signal transmission unit 130 is connected to the server side control unit 120. The request signal transmission unit 130 transmits a request signal generated by the request signal generation unit 122 to a terminal apparatus selected by the terminal selection unit 123.

As described above, when there is one terminal apparatus (e.g. only the terminal apparatus 200-1), i.e. when the server 100 does not include the terminal selection unit 123, the request signal transmission unit 130 transmits a request signal to the terminal apparatus 200-1.

Next, using FIG. 1, a detailed configuration of the terminal apparatus 200 will be described.

As illustrated in FIG. 1, the terminal apparatus 200 includes a request signal reception unit 210, a terminal side control unit 220, and a terminal side data communication unit 230.

The terminal apparatus 200 is connected to the communication network 300 via a wireless line. Further, the terminal apparatus 200 is connected to the server 100 via the communication network 300. The terminal apparatus 200 mutually executes data communication with the server 100 via the communication network 300.

Herein, a case in which there are three terminal apparatuses 200 is illustrated, but there may be two or four or more terminal apparatuses 200. Further, there may be one terminal apparatus 200.

As illustrated in FIG. 1, the request signal reception unit 210 is connected to the terminal side control unit 220. The request signal reception unit 210 receives a request signal transmitted by the request signal transmission unit 130 of the server 100.

As illustrated in FIG. 1, the terminal side control unit 220 is connected to the request signal reception unit 210 and the terminal side data communication unit 230. The terminal side control unit 220 controls the entirety of the terminal apparatus 200. The terminal side control unit 220 receives a request signal received by the request signal reception unit 210 and instructs the terminal side data communication unit 230 to execute data communication with the server 100.

As illustrated in FIG. 1, the terminal side data communication unit 230 is connected to the terminal side control unit 220.

The terminal side data communication unit 230 transmits data to the server side data communication unit 110 of the server 100 via the communication network 300. The terminal side data communication unit 230 transmits information on a communication quality in the terminal apparatus 200 as described above.

Further, the terminal side data communication unit 230 receives data transmitted from the server side data communication unit 110 of the server 100 via the communication network 300.

Further, the terminal side data communication unit 230 receives an instruction from the terminal side control unit 220 and executes data communication with the server 100 on the basis of a request signal received by the request signal reception unit 210.

As illustrated in FIG. 1, the communication network 300 is connected to both the server 100 and the terminal apparatus 200. The communication network 300 is a network for communication such as the Internet or the like.

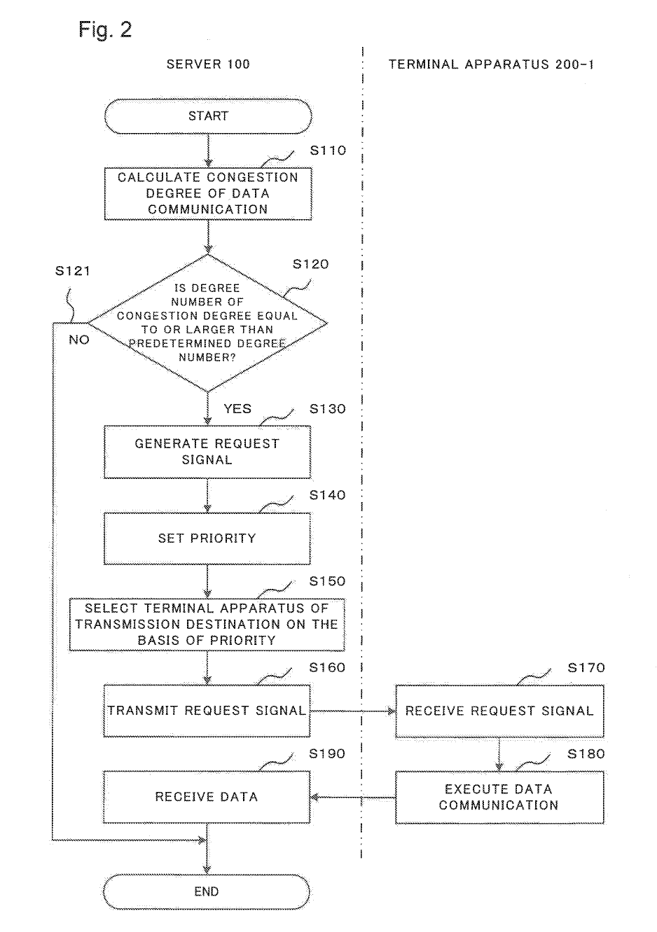

Next, using FIG. 2, an operation of the radio communication system 1000 including a server 100 and a terminal apparatus 200 will be described. FIG. 2 is a diagram illustrating an operation flow of the communication system 1000 including the server 100 and the terminal apparatus 200.

It is assumed that of the terminal apparatuses 200, the terminal apparatus 200-3 is executing data communication with the server 100. It is assumed that of the terminal apparatuses 200-1 and 200-2 being not executing data communication with the server 100, the terminal apparatus 200-1 executes data communication with the server 100 in accordance with a request signal of the server 100.

A case in which specifically, the terminal apparatus 200-1 transmits data to the server 100 will be described.

First, as illustrated in FIG. 2, the server side congestion degree calculation unit 121 of the server 100 calculates a first congestion degree of data communication executed with the terminal apparatus 200 (Step (hereinafter, referred to as S) 110).

A specific method in which the server side congestion degree calculation unit 121 calculates a first congestion degree of data communication executed with the terminal apparatus 200 will be described.

First, the server side congestion degree calculation unit 121 calculates a throughput of data communication executed with the terminal apparatus 200-3 being executing data communication.

Specifically, the server side congestion degree calculation unit 121 calculates a throughput [bps] of data communication from a data communication amount [bits] per unit time [s] with the terminal apparatus 200-3.

In other words, a throughput Thrpt1 [bps] of data communication executed with the terminal apparatus 200-3 is represented by following Equation (1).

Thrpt1 [bps]=DataSize [bits]/Time [s] (1)

DataSize: data communication amount

Time: unit time

The server side congestion degree calculation unit 121 calculates a first congestion degree of data communication executed with the terminal apparatus 200, for example, as described below, from a throughput of data communication executed with the terminal apparatus 200-3 calculated as described above.

The server side congestion degree calculation unit 121 executes calculation as a congestion degree 1 when Thrpt1 is equal to or larger than a predetermined threshold Thresh1 (e.g. 20 [kbps]), executes calculation as a congestion degree 2 when Thrpt1 is a value Thresh2 in a predetermined range (e.g. 11 to 19 [kbps]), and executes calculation as a congestion degree 3 when Thrpt1 is equal to or smaller than a predetermined threshold Thresh3 (e.g. 10 [kbps]).

Regarding the congestion degree, it is assumed that a congestion degree becomes higher with an increase in degree number. In other words, it is indicated that with an increase in a degree number of the congestion degree, data communication executed between the server 100 and the terminal apparatus 200 is congested.

As described above, the server side congestion degree calculation unit 121 may calculate a first congestion degree on the basis of information on a communication quality. The server side congestion degree calculation unit 121 may calculate a first congestion degree, for example, on the basis of information on a communication quality and a predetermined threshold corresponding to the communication quality.

Further, the server side congestion degree calculation unit 121 may calculate a first congestion degree on the basis of a throughput of data communication executed with the terminal apparatus 200-3 and information on a communication quality.

Return to FIG. 2, and the request signal generation unit 122 determines whether a degree number of the first congestion degree of data communication calculated by the server side congestion degree calculation unit 121 in processing of S110 is equal to or larger than a predetermined degree number (e.g. a congestion degree 2) (S120).

The request signal generation unit 122 does not generate, when the degree number of the first congestion degree of data communication is not equal to or larger than the predetermined degree number, i.e. smaller than the predetermined degree number (S120, NO), a request signal (S121).

On the other hand, the request signal generation unit 122 generates, when the degree number of the first congestion degree of data communication is equal to or larger than the predetermined degree number (S120, YES), a request signal (S130).

The priority setting unit 124 sets a priority of each of the terminal apparatuses 200-1 and 200-2 being not executing data communication among the terminal apparatuses 200 (S140).

It is assumed that the priority setting unit 124 sets, from a previously set priority order for each terminal apparatus 200, the terminal apparatus 200-1 as a priority 1 and the terminal apparatus 200-2 as a priority 2.

It is assumed that a user of the server 100 optionally sets a priority order for each terminal apparatus 200 in advance.

Further, regarding the priority, it is assumed that a priority becomes higher with a decrease in degree number. In other words, the priority 1 is higher in priority than the priority 2.

The priority setting unit 124 may set a priority for each of the terminal apparatuses 200 on the basis of actual results of data communication executed with the terminal apparatuses 200. The priority setting unit 124 may set, when, for example, the terminal apparatuses 200 receive data (e.g. web contents) from the server 100, a priority of a terminal apparatus having a long elapsed time from a reception start at a higher level.

Further, the priority setting unit 124 may set, when, for example, the terminal apparatuses 200 transmit data of a predetermined data size to the server 100, a priority of a terminal apparatus having a large untransmitted data size at a higher level. It is assumed that the server 100 is measuring an untransmitted data size of each terminal apparatus 200.

Return to FIG. 2, and the terminal selection unit 123 selects the terminal apparatus 200-1 to be a transmission destination of a request signal among the terminal apparatuses 200 on the basis of the priority set by the priority setting unit 124 (S150).

The terminal selection unit 123 may also select the terminal apparatus 200-2 assigned as the priority 2 as a transmission destination of a request signal in addition to the terminal apparatus 200-1 assigned as the priority 1 in accordance with a first congestion degree of data communication.

The request signal transmission unit 130 transmits a request signal to the terminal apparatus 200-1 selected by the terminal selection unit 123 (S160).

The request signal reception unit 210 of the terminal apparatus 200-1 receives the request signal (S170).

The terminal side data communication unit 230 of the terminal apparatus 200-1 transmits data to the server 100 and executes data communication with the server 100 (S180).

Last, the server side data communication unit 110 of the server 100 receives the data transmitted from the terminal apparatus 200-1 (S190).

As described above, the communication system 1000 in the first exemplary embodiment of the present invention includes a server 100 and a terminal apparatus 200 that executes data communication with the server 100.

The server 100 includes a server side congestion degree calculation unit 121, a request signal generation unit 122, and a request signal transmission unit 130.

The server side congestion degree calculation unit 121 calculates a first congestion degree of data communication executed with the terminal apparatus 200. The request signal generation unit 122 generates a request signal that is a signal for making a request of data communication to the terminal apparatus 200 on the basis of the first congestion degree of data communication calculated by the server side congestion degree calculation unit 121. The request signal transmission unit 130 transmits the request signal generated by the request signal generation unit 122 to the terminal apparatus 200.

The terminal apparatus 200 includes a terminal side data communication unit 230 and a request signal reception unit 210. The terminal side data communication unit 230 executes data communication with the server 100. The request signal reception unit 210 receives the request signal transmitted by the request signal transmission unit 130. The terminal side data communication unit 230 executes data communication with the server 100 on the basis of the request signal received by the request signal reception unit 210.

In this manner, in the communication system 1000 in the first exemplary embodiment of the present invention, in accordance with a first congestion degree of data communication, the server 100 and the terminal apparatus 200 execute data communication. Specifically, when the first congestion degree of data communication is low, the server 100 and the terminal apparatus 200 execute data communication, and when the first congestion degree of data communication is high, the server 100 and the terminal apparatus 200 do not execute data communication.

Therefore, a situation where in spite of congestion of data communication, the terminal apparatus 200 attempts data communication with the server 100, and thereby data communication is further congested is not generated. As a result, the communication system 1000 including the server 100 and the terminal apparatus 200 can execute data communication more efficiently.

Further, the communication system 1000 in the first exemplary embodiment of the present invention includes a plurality of terminal apparatuses 200. The server 100 includes a terminal selection unit 123 that selects a terminal apparatus to be a transmission destination of a request signal among the plurality of terminal apparatuses 200. A request signal transmission unit 130 transmits a request signal to the terminal apparatus selected by the terminal selection unit 123.

Thereby, the server 100 transmits, when data communication is not congested, the request signal to only the selected terminal apparatus of the plurality of terminal apparatuses 200 and executes data communication. In other words, the server 100 does not execute data communication with all of the plurality of terminal apparatuses 200 at the same time. As a result, the communication system 1000 can reduce congestion of data communication, compared with a case in which a terminal apparatus 200 to be a transmission destination of a request signal is not selected.

Further, in the communication system 1000 in the first exemplary embodiment of the present invention, the server 100 includes a priority setting unit 124 that sets a priority of each of a plurality of terminal apparatuses 200. The terminal selection unit 123 selects a terminal apparatus to be a transmission destination of a request signal among the plurality of terminal apparatuses 200 on the basis of the priority set by the priority setting unit 124.

Thereby, the server 100 can preferentially execute data communication with a terminal apparatus having a high priority (to be subjected to preferential data communication) among the plurality of terminal apparatuses 200. As a result, the communication system 1000 can execute data communication more efficiently.

The communication method in the first exemplary embodiment of the present invention is performed between a server 100 and a terminal apparatus 200 that executes data communication with the server 100. The communication method includes a server side congestion degree calculation step, a request signal generation step, a request signal transmission step, a request signal reception step, and a data communication execution step.

In the server side congestion degree calculation step, the server 100 calculates a first congestion degree of data communication executed with the terminal apparatus 200. In the request signal generation step, the server 100 generates a request signal that is a signal for making a request of data communication to the terminal apparatus 200 on the basis of the first congestion degree of data communication calculated by the server side congestion degree calculation step.

In the request signal transmission step, the server 100 transmits the request signal generated by the request signal generation step to the terminal apparatus 200. In the request signal reception step, the terminal apparatus 200 receives the request signal transmitted by the request signal transmission step. In the data communication execution step, the terminal apparatus 200 executes data communication with the server 100 on the basis of the request signal received by the request signal reception step.

The communication method is provided as an invention of a method from an invention of a system that is the above-described communication system 1000, and therefore produces the same advantageous effect as the above-described communication system 1000.

Further, the program in the first exemplary embodiment of the present invention is used in a system including a server 100 and a terminal apparatus 200 that executes data communication with the server 100. The program causes a computer to execute a server side congestion degree calculation step, a request signal generation step, a request signal transmission step, a request signal reception step, and a data communication execution step.

In the server side congestion degree calculation step, the server 100 calculates a first congestion degree of data communication executed with the terminal apparatus 200. In the request signal generation step, the server 100 generates a request signal that is a signal for making a request of data communication to the terminal apparatus 200 on the basis of the first congestion degree of data communication calculated by the server side congestion degree calculation step.

In the request signal transmission step, the server 100 transmits the request signal generated by the request signal generation step to the terminal apparatus 200. In the request signal reception step, the terminal apparatus 200 receives the request signal transmitted by the request signal transmission step. In the data communication execution step, the terminal apparatus 200 executes data communication with the server 100 on the basis of the request signal received by the request signal reception step.

The program is provided as an invention of a program from an invention of a system that is the above-described communication system 1000, and therefore produces the same advantageous effect as the above-described communication system 1000.

Further, the terminal apparatus 200 in the first exemplary embodiment of the present invention executes data communication with the server 100. The terminal apparatus 200 includes a terminal side data communication unit 230 and a request signal reception unit 210.

The terminal side data communication unit 230 executes data communication with the server 100. The request signal reception unit 210 receives a request signal of data communication transmitted from the server 100. The terminal side data communication unit 230 executes data communication with the server 100 on the basis of the request signal of data communication received by the request signal reception unit 210.

In this manner, the terminal apparatus 200 executes data communication with the server 100 in accordance with a request signal generated in the server 100 on the basis of a first congestion degree of data communication, and therefore produces the same advantageous effect as the above-described communication system 1000.

Further, the server 100 in the first exemplary embodiment of the present invention executes data communication with the terminal apparatus 200. The server 100 includes a server side congestion degree calculation unit 121, a request signal generation unit 122, and a request signal transmission unit 130.

The server side congestion degree calculation unit 121 calculates a first congestion degree of data communication executed with the terminal apparatus 200. The request signal generation unit 122 generates a request signal that is a signal for making a request of data communication to the terminal apparatus 200 on the basis of the first congestion degree of data communication calculated by the server side congestion degree calculation unit 121. The request signal transmission unit 130 transmits the request signal generated by the request signal generation unit 122 to the terminal apparatus 200.

In this manner, the server 100 transmits a request signal generated on the basis of a first congestion degree of data communication to the terminal apparatus 200 and executes data communication with the terminal apparatus 200 of a transmission destination, and therefore produces the same advantageous effect as the above-described communication system 1000.

### Second Exemplary Embodiment

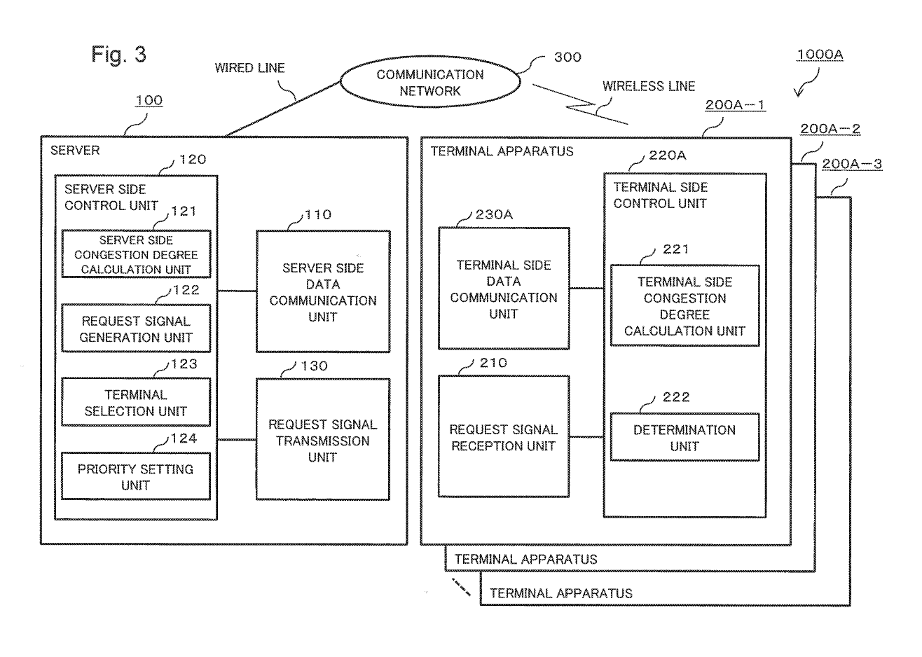

Using FIG. 3, a detailed configuration of a communication system 1000A in a second exemplary embodiment of the present invention will be described. FIG. 3 is a block diagram illustrating a configuration of the communication system 1000A. In FIG. 3, the same components as the respective components illustrated in FIG. 1 are assigned with the same reference signs as the reference signs illustrated in FIG. 1.

As illustrated in FIG. 3, the communication system 1000A includes a server 100 and a plurality of terminal apparatuses 200A-1, 200A-2, and 200A-3. In the following description, when it is not specifically necessary to discriminate and describe each of the plurality of terminal apparatuses 200A-1, 200A-2, and 200A-3, these terminal apparatuses are collectively referred to as a terminal apparatus 200A.

As illustrated in FIG. 3, the server 100 includes a server side data communication unit 110, a server side congestion degree calculation unit 121, a request signal generation unit 122, a terminal selection unit 123, a priority setting unit 124, and a request signal transmission unit 130.

The terminal apparatus 200A includes a request signal reception unit 210, a terminal side congestion degree calculation unit 221, a determination unit 222, and a terminal side data communication unit 230A.

FIG. 1 and FIG. 3 will be compared. In FIG. 3, a terminal side control unit 220A of the terminal apparatus 200A is different from the terminal side control unit 220 of the terminal apparatus 200 illustrated in FIG. 1 in a point in which the terminal side control unit 220A includes the terminal side congestion degree calculation unit 221 and the determination unit 222. In the following description, description of the same components as the components illustrated in FIG. 1 will be omitted.

The terminal side control unit 220A outputs a determination result of the determination unit 222, to be described later, to the terminal side data communication unit 230A.

The terminal side data communication unit 230A executes data communication with the server 100 at a predetermined cycle (e.g. 30 seconds). The predetermined cycle can be optionally set by a user as appropriate.

Further, the terminal side data communication unit 230A executes data communication with the server 100 on the basis of a request signal received by the request signal reception unit 210 in the same manner as the terminal side data communication unit 230 of the first exemplary embodiment. The terminal side data communication unit 230A continues data communication or interrupts data communication until a beginning of a next cycle on the basis of a determination result of the determination unit 222 to be described later.

The terminal side congestion degree calculation unit 221 calculates a second congestion degree of data communication when executing data communication with the server 100 at a predetermined cycle. The second congestion degree of data communication refers to a congestion degree calculated on the terminal apparatus 200A side.

The second congestion degree of data communication is information such as a congestion degree of data communication used when the determination unit 222, to be descried later, determines whether to continue data communication or interrupt data communication until a predetermined cycle, a utilization rate of radio resources shared by the terminal apparatus 200, and the like.

The determination unit 222 determines whether to continue data communication or interrupt data communication until a predetermined cycle on the basis of a second congestion degree of data communication calculated by the terminal side congestion degree calculation unit 221.

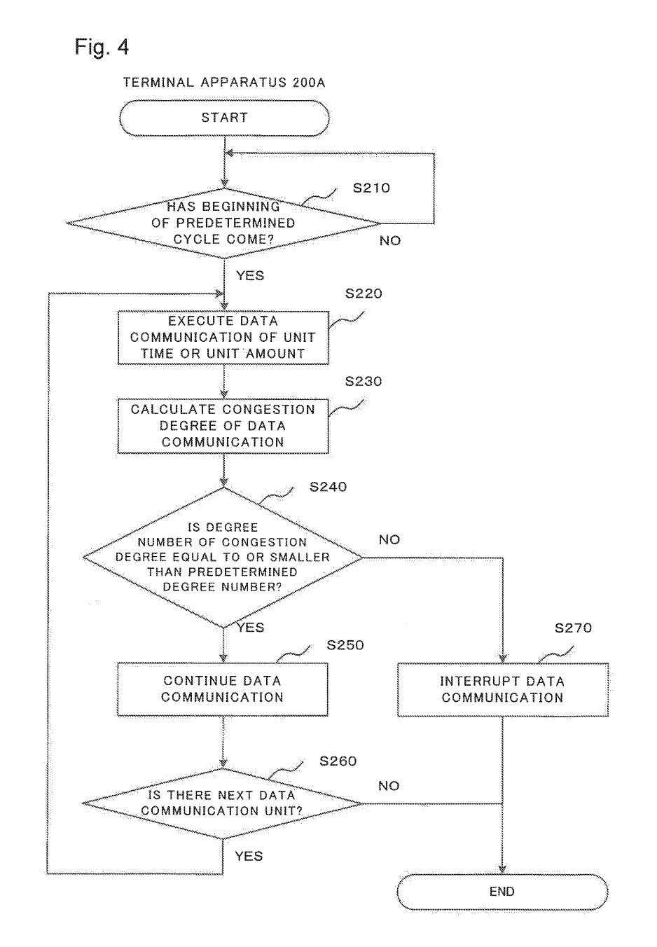

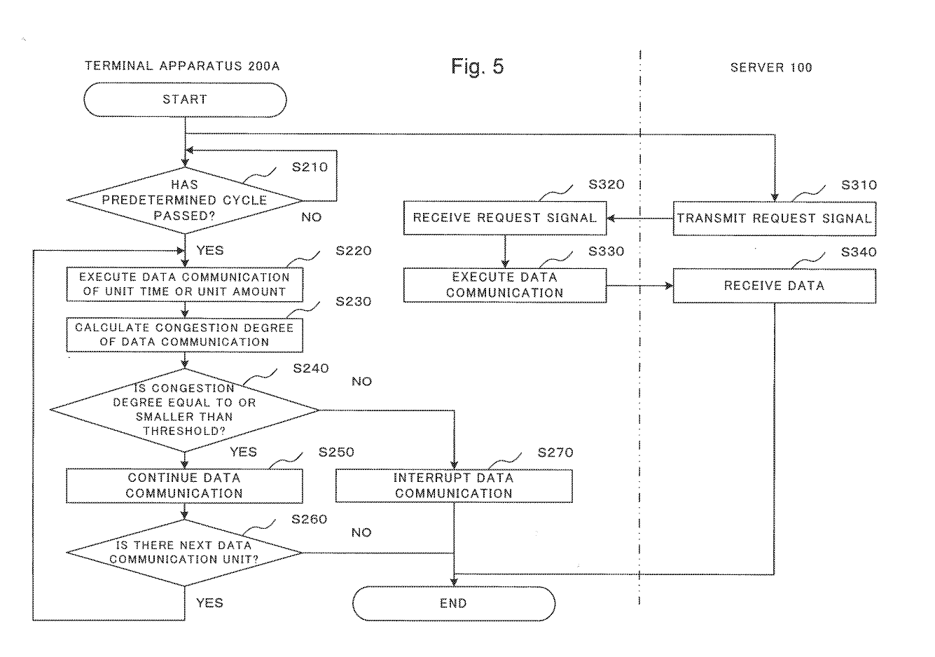

Next, using FIG. 4 and FIG. 5, an operation of the terminal apparatus 200A will be described in detail.

First, using FIG. 4, normal operations in which the terminal apparatus 200A executes data communication with the server 100 at a predetermined cycle will be described in detail. FIG. 4 is a diagram illustrating an operation flow in which the terminal apparatus 200A executes data communication with the server 100 at a predetermined cycle.

First, the terminal side data communication unit 230A determines whether a beginning of a predetermined cycle has come (S210).

When it is determined that a beginning of the predetermined cycle has not come (S210, NO), the terminal side data communication unit 230A repeats processing of S210 until it is determined that a beginning of the predetermined cycle has come.

On the other hand, when it is determined that a beginning of the predetermined cycle has come (S210, YES), the terminal side data communication unit 230A executes data communication of a unit time or a unit amount with the server 100 (S220). This data communication is one for calculating a second congestion degree of data communication executed with the server 100. The unit time or the unit amount in processing of S220 is appropriately changeable and appropriately set by a user.

When the unit time or the unit amount is relatively large, a second congestion degree is accurately calculable, but a load of the communication network 300 side increases.

In contrast, while when the unit time or the unit amount is relatively small, a load of the communication network 300 side can be reduced, it becomes difficult to accurately calculate a second congestion degree. Further, when a data amount of data communication is relatively large, division processing of data or reconstruction processing on the server 100 side is needed.

The terminal side congestion degree calculation unit 221 calculates a second congestion degree of data communication executed with the server 100 (S230).

Specifically, the terminal side congestion degree calculation unit 221 calculates a second congestion degree of data communication on the basis of a throughput of data communication executed with the server 100 in processing of S220. A calculation method of a throughput and a calculation method of a second congestion degree based on the throughput are the same as S110 of FIG. 2, and therefore description thereof will be omitted.

The determination unit 222 determines whether a degree number of the second congestion degree of data communication calculated by the terminal side congestion degree calculation unit 221 in processing of S230 is equal to or smaller than a predetermined degree number (e.g. a congestion degree 2) (S240).

The determination unit 222 determines, when the degree number of the second congestion degree is equal to or smaller than the predetermined degree number (S240, YES), to continue data communication (S250).

The terminal side data communication unit 230A returns, when there is a next data communication unit (S260, YES), to processing of S220 and executes data communication of a unit time or a unit amount. The case in which there is a next data communication unit refers to a case in which untransmitted data is accumulated after data communication of a unit time or a unit amount executed in processing of S220.

Conversely, the terminal side data communication unit 230A does not execute, when there is no next data communication unit (S260, NO), data communication with the server 100 until a beginning of a next cycle.

Return to processing of S240, and the determination unit 222 determines, when the degree number of the second congestion degree is not equal to or smaller than the predetermined degree number (S240, NO), to interrupt data communication until a beginning of a next cycle (S270). When the server 100 includes a resume mechanism, the terminal side data communication unit 230A can restart data communication from a point where data communication has been interrupted at the next cycle.

Next, using FIG. 5, operations at the time when the terminal apparatus 200A has received a request signal transmitted from the server 100 when executing data communication with the server 100 at a predetermined cycle will be described. FIG. 5 is a diagram illustrating an operation flow at the time when the terminal apparatus 200A has received a request signal. In FIG. 5, steps overlapped with those in FIG. 4 are assigned with the same reference sings, and detailed description thereof will be omitted.

It is assumed that the terminal apparatus 200A is executing processing from S210 to S270.

During processing in which the terminal apparatus 200A is executing processing from S210 to S270, when the request signal transmission unit 130 of the server 100 transmits a request signal (S310), the request signal reception unit 210 of the terminal apparatus 200A receives the request signal (S320).

Last, the terminal side data communication unit 230A transmits data to the server 100 and thereby executes data communication with the server 100 (S330). The server 100 receives data transmitted from the terminal apparatus 200A (S340).

At that time, the terminal side data communication unit 230A transmits, to the server 100, untransmitted data accumulated since the last transmission in processing in S220. Further, when there is no accumulated untransmitted data, the terminal side data communication unit 230A does not execute data communication with the server 100.

Further, the terminal apparatus 200A may execute processing of S230 and thereafter, after the terminal side data communication unit 230A executes processing of S330.

As described above, in the communication system 1000A in the second exemplary embodiment of the present invention, the terminal side data communication unit 230A executes data communication with the server 100 at a predetermined cycle.

In this manner, in the communication system 1000A in the second exemplary embodiment of the present invention, the terminal apparatus 200A executes data communication in accordance with a request signal transmitted from the server 100 and also executes data communication with the server 100 at a predetermined cycle.

Thereby, a user using the terminal apparatus 200A can execute data communication with the server 100 at a predetermined cycle able to be appropriately set, and therefore can execute data communication in accordance with an intended use of the user or a use situation.

Further, in the communication system 1000A in the second exemplary embodiment of the present invention, the terminal apparatus 200A includes a terminal side congestion degree calculation unit 221 and a determination unit 222.

The terminal side congestion degree calculation unit 221 calculates a second congestion degree of data communication executed with the server 100. The determination unit 222 determines whether to continue data communication or interrupt the data communication until a beginning of a next cycle on the basis of the second congestion degree of data communication calculated by the terminal side congestion degree calculation unit 221.

The terminal side data communication unit 230A executes data communication with the server 100 on the basis of a request signal received by the request signal reception unit 210 and also continues data communication or interrupts data communication until a beginning of a next cycle on the basis of the determination result of the determination unit 222.

In this manner, in the communication system 1000A in the second exemplary embodiment of the present invention, the terminal apparatus 200A continues data communication or interrupts data communication until a beginning of a next cycle in accordance with a second congestion degree of data communication. Therefore, a situation where in spite of congestion of data communication, the terminal apparatus 200A attempts data communication with the server 100 at a predetermined cycle, and thereby data communication is further congested is not generated.

As a result, the communication system 1000A can execute data communication more efficiently without promoting congestion of data communication.

Further, in the communication system 1000A in the second exemplary embodiment of the present invention, the terminal apparatus 200A executes, when receiving a request signal from the server 100 on the basis of a first congestion degree, data communication with the server 100, even during waiting (during interruption of data communication) until a beginning of a next cycle.

Thereby, even during waiting (or during interruption of data communication) until a beginning of a next cycle, when a first congestion degree of data communication decreases, the server 100 and the terminal apparatus 200A can execute data communication with each other.

Therefore, as a result, even when a congestion degree of data communication varies at a relatively short cycle, utilization efficiency of data communication between the terminal apparatus 200A and the server 100 can be improved.

### Third Exemplary Embodiment

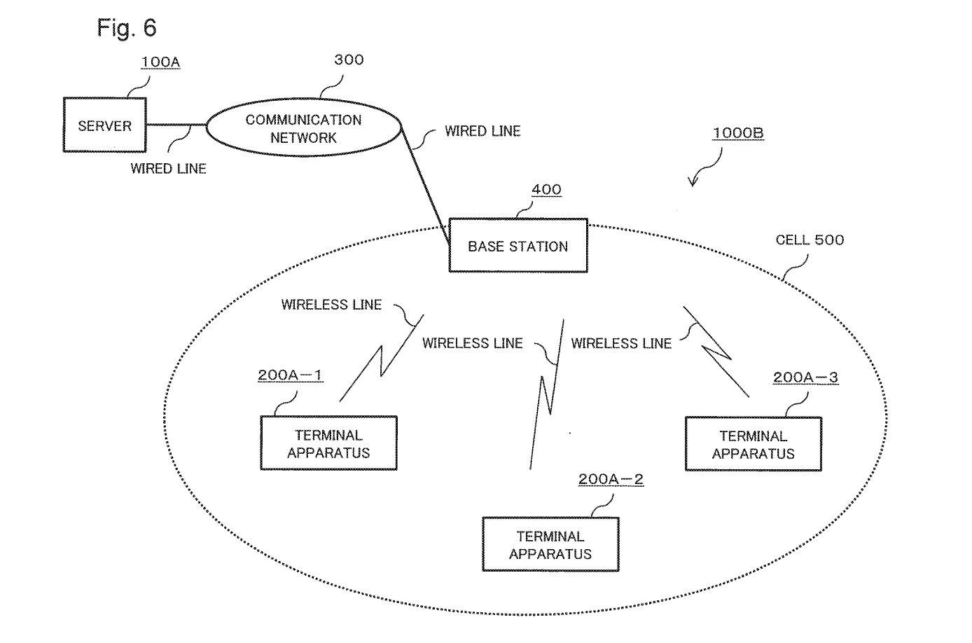

Using FIG. 6, a detailed configuration of a communication system 1000B in a third exemplary embodiment of the present invention will be described. FIG. 6 is a block diagram illustrating a configuration of the communication system 1000B. In FIG. 6, the same components as the respective components illustrated in FIGS. 1 to 5 are assigned with the same reference signs as the reference signs attached in FIGS. 1 to 5.

As illustrated in FIG. 6, the communication system 1000B includes a server 100A, a terminal apparatus 200A, and a base station 400. In FIG. 6, illustration of the respective components of the server 100A and the terminal apparatus 200A is omitted.

FIG. 3 and FIG. 6 will be compared. In FIG. 6, the communication system 1000B is different from the communication system 1000A illustrated in FIG. 3 in a point in which the communication system 1000B further includes the base station 400. In the following description, description of the same components as the components illustrated in FIGS. 1 to 5 will be omitted.

As illustrated in FIG. 6, the server 100A is connected to the base station 400 via a communication network 300.

A server side data communication unit 110 of the server 100A inquires of the base station 400 about information on a utilization rate of the base station 400. Further, the server side data communication unit 110 receives and acquires the information on a utilization rate of the base station 400 from the base station 400. The information on a utilization rate of the base station 400 refers to, for example, information on a utilization rate or the like of radio resources shared by the terminal apparatus 200A. The utilization rate of radio resources referred to here is a ratio of a resource block allocated to the terminal apparatus 200A to all resource blocks held by the base station 400.

A server side congestion degree calculation unit 121 of the server 100A calculates a first congestion degree on the basis of the information on a utilization rate of the base station 400 received by the server side data communication unit 110. The server side congestion degree calculation unit 121 calculates a first congestion degree, for example, on the basis of a utilization rate of radio resources shared by the terminal apparatus 200A and a predetermined value. A more specific calculation method is the same as the case described in S110 of FIG. 2, and therefore description thereof will be omitted.

As illustrated in FIG. 6, the base station 400 is connected to the communication network 300 via a wired line. Further, the base station 400 is connected to the server 100A via the communication network 300.

The base station 400 accommodates the terminal apparatus 200A in a cell 500. The base station 400 is connected to the terminal apparatus 200A via a wireless line. The base station 400 executes data communication with the server 100A and the terminal apparatus 200A.

Thereby, the server 100A and the terminal apparatus 200A execute data communication with each other via the base station 400.

The base station 400 receives an inquiry from the server side data communication unit 110 and responds thereto. At that time, the base station 400 transmits information on a utilization rate of the base station 400 to the server 100A.

While, herein, an example in which there is one base station 400 is illustrated, there may be a plurality of base stations 400. When there are a plurality of base stations 400, each base station 400 accommodates, in a cell 500 thereof, respective terminal apparatuses.

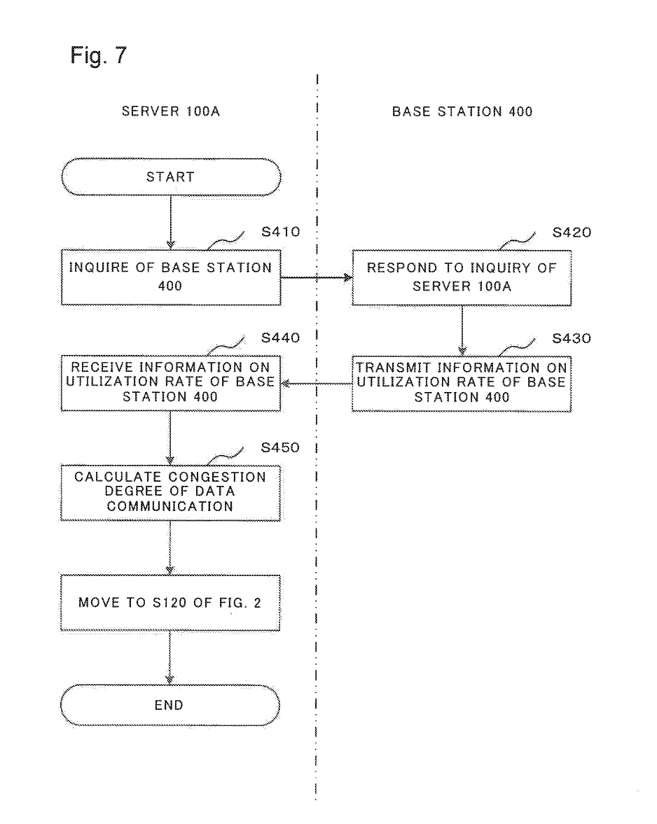

Next, using FIG. 7, an operation of the communication system 1000B will be described in detail. FIG. 7 is a diagram illustrating an operation flow of the communication system 1000B.

First, the server side data communication unit 110 of the server 100A inquires of the base station 400 about information on a utilization rate of the base station 400 (S410).

The base station 400 receives the inquiry from the server side data communication unit 110 and responds thereto (S420).

The base station 400 transmits the information on a utilization rate of the base station 400 to the server 100A (S430).

The server side data communication unit 110 of the server 100A receives the information on a utilization rate of the base station 400 (S440).

Last, the server side congestion degree calculation unit 121 of the server 100A calculates a first congestion degree on the basis of the information on a utilization rate of the base station 400 (S450). Thereafter, the server 100A executes processing of S120 and hereafter of FIG. 2.

As described above, in the communication system 1000B in the third exemplary embodiment of the present invention, the server side congestion degree calculation unit 121 calculates a first congestion degree on the basis of information on a utilization rate of the base station 400. Thereby, the server 100A can calculate a first congestion degree on the basis of information on a utilization rate of the base station 400 that is unique information of the base station 400. Therefore, the server 100A can calculate a first congestion degree more accurately. As a result, the communication system 1000B can more efficiently execute data communication with the terminal apparatus 200A.

### Fourth Exemplary Embodiment

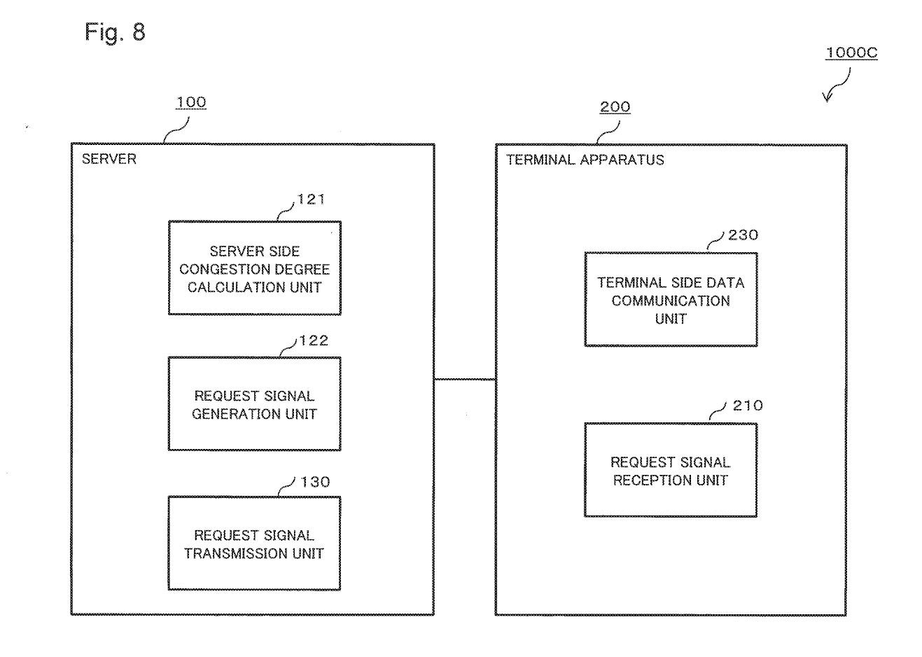

Using FIG. 8, a detailed configuration of a communication system 1000C in a fourth exemplary embodiment of the present invention will be described. FIG. 8 is a block diagram illustrating a configuration of the communication system 1000C. In FIG. 8, the same components as the respective components illustrated in FIG. 1 to FIG. 7 are assigned with the same reference signs as the reference signs attached in FIG. 1 to FIG. 7.

As illustrated in FIG. 8, the communication system 1000C includes a server 100 and a terminal apparatus 200 that executes data communication with the server 100. The server 100 includes a server side congestion degree calculation unit 121, a request signal generation unit 122, and a request signal transmission unit 130.

The server side congestion degree calculation unit 121 calculates a first congestion degree of data communication executed with the terminal apparatus 200. The request signal generation unit 122 generates a request signal that is a signal for making a request of data communication to the terminal apparatus 200 on the basis of the first congestion degree calculated by the server side congestion degree calculation unit 121. The request signal transmission unit 130 transmits the request signal generated by the request signal generation unit 122 to the terminal apparatus 200.

The terminal apparatus 200 includes a terminal side data communication unit 230 and a request signal reception unit 210. The terminal side data communication unit 230 executes data communication with the server 1000C. The request signal reception unit 210 receives the request signal transmitted by the request signal transmission unit 130. The terminal side data communication unit 230 executes data communication with the server 1000C on the basis of the request signal received by the request signal reception unit 210. Thereby, data communication can be executed more efficiently.

A part or all of the exemplary embodiments can be described as the following supplementary notes but the present invention is not limited to the following.

### [Supplementary Note 1]

A communication system including:

a server; and a terminal apparatus that executes data communication with the server, wherein

the server includes

a server side congestion degree calculation unit that calculates a first congestion degree of the data communication executed with the terminal apparatus,

a request signal generation unit that generates a request signal that is a signal for making a request of the data communication to the terminal apparatus on the basis of the first congestion degree calculated by the server side congestion degree calculation unit, and

a request signal transmission unit that transmits the request signal generated by the request signal generation unit to the terminal apparatus, and

the terminal apparatus includes

a terminal side data communication unit that executes the data communication with the server and

a request signal reception unit that receives the request signal transmitted by the request signal transmission unit,

the terminal side data communication unit executing the data communication with the server on the basis of the request signal received by the request signal reception unit.

### [Supplementary Note 2]

The communication system according to Supplementary note 1, including

a plurality of the terminal apparatuses, wherein

the server includes a terminal selection unit that selects the terminal apparatus to be a transmission destination of the request signal among the plurality of terminal apparatuses, and

the request signal transmission unit transmits the request signal to the terminal apparatus selected by the terminal selection unit.

### [Supplementary Note 3]

The communication system according to Supplementary note 2, wherein

the server includes a priority setting unit that sets a propriety of each of the plurality of terminal apparatuses, and

the terminal selection unit selects the terminal apparatus to be a transmission destination of the request signal among the plurality of terminal apparatuses on the basis of the priority set by the priority setting unit.

### [Supplementary Note 4]

The communication system according to any one of Supplementary notes 1 to 3, wherein the terminal side data communication unit executes the data communication with the server at a predetermined cycle.

### [Supplementary Note 5]

The communication system according to Supplementary note 4, wherein

the terminal apparatus includes

a terminal side congestion degree calculation unit that calculates a second congestion degree of the data communication executed with the server and a determination unit that determines whether to continue the data communication or interrupt the data communication until the predetermined cycle on the basis of the second congestion degree calculated by the terminal side congestion degree calculation unit, and the terminal side data communication unit executes the data communication with the server on the basis of the request signal received by the request signal reception unit and continues the data communication or interrupts the data communication until the predetermined cycle on the basis of a determination result of the determination unit.

### [Supplementary Note 6]

The communication system according to any one of Supplementary notes 1 to 5, wherein the server side congestion degree calculation unit calculates the first congestion degree on the basis of a throughput of the data communication between the server and the terminal apparatus.

### [Supplementary Note 7]

The communication system according to any one of Supplementary notes 1 to 6, wherein the server side congestion degree calculation unit calculates the first congestion degree on the basis of information on a communication quality in the terminal apparatus.

### [Supplementary Note 8]

The communication system according to any one of Supplementary notes 1 to 7, further including a base station that executes data communication with the server and the terminal apparatus, wherein

the server side congestion degree calculation unit calculates the first congestion degree on the basis of information on a utilization rate of the base station.

### [Supplementary Note 9]

A communication method, wherein

when a server and a terminal apparatus execute data communication,

the server calculates a first congestion degree of the data communication executed with the terminal apparatus,

generates a request signal that is a signal for making a request of the data communication to the terminal apparatus on the basis of the calculated first congestion degree, and

transmits the generated request signal to the terminal apparatus; and

the terminal apparatus receives the request signal transmitted by the server and

executes the data communication with the server on the basis of the received request signal.

### [Supplementary Note 10]

A storage medium storing a program for causing a computer to execute:

server side congestion degree calculation processing, performed by a server, for calculating a first congestion degree of data communication executed with a terminal apparatus,

request signal generation processing, performed by a server, for generating a request signal that is a signal for making a request of the data communication to the terminal apparatus on the basis of the first congestion degree calculated by the server side congestion degree calculation processing,

request signal transmission processing, performed by a server, for transmitting the request signal generated by the request signal generation processing to the terminal apparatus,

request signal reception processing, performed by the terminal apparatus, for receiving the request signal transmitted by the request signal transmission processing, and

data communication execution processing, performed by the terminal apparatus, for executing the data communication with the server on the basis of the request signal received by the request signal reception processing.

### [Supplementary Note 11]

A terminal apparatus including:

a terminal side data communication unit that executes data communication with a server; and

a request signal reception unit that receives, from the server, a request signal for making a request of the data communication to the terminal apparatus by the server, wherein

the terminal side data communication unit executes the data communication with the server on the basis of the request signal of the data communication received by the request signal reception unit.

### [Supplementary Note 12]

A server including:

a server side congestion degree calculation unit that calculates a first congestion degree of data communication executed with a terminal apparatus;

a request signal generation unit that generates a request signal that is a signal for making a request of the data communication to the terminal apparatus on the basis of the first congestion degree calculated by the server side congestion degree calculation unit; and

a request signal transmission unit that transmits the request signal generated by the request signal generation unit to the terminal apparatus.

As above, the present invention has been described based on the exemplary embodiments. An exemplary embodiment is just an illustration, and various kinds of changes, addition or subtraction and combinations may be added to each of the above-mentioned exemplary embodiments unless it deviates from the main points of the present invention. It is understood by a person skilled in the art that modification made by adding such changes, addition/subtraction and combinations are also included in the scope of the present invention.

This application claims priority based on Japanese application Japanese Patent Application No. 2014-058494, filed on Mar. 20, 2014, the disclosure of which is incorporated herein in its entirety.

### REFERENCE SIGNS LIST

100, 100A Server
110 Server side data communication unit
120 Server side control unit
121 Server side congestion degree calculation unit
122 Request signal generation unit
123 Terminal selection unit
124 Priority setting unit
130 Request signal transmission unit
200, 200A Terminal apparatus
210 Request signal reception unit
220, 220A Terminal side control unit
221 Terminal side congestion degree calculation unit
222 Determination unit
230, 230A Terminal side data communication unit
300 Communication network
400 Base station
500 Cell
1000, 1000A, 1000B Communication system

What is claimed is:

1. A communication system comprising:
a server; and
a terminal apparatus that executes data communication with the server, wherein
the server comprises
a server side congestion degree calculation unit configured to calculate a first congestion degree of the data communication executed with the terminal apparatus,
a request signal generation unit configured to generate a request signal that is a signal for making a request of the data communication to the terminal apparatus on the basis of the first congestion degree calculated by the server side congestion degree calculation unit, and
a request signal transmission unit configured to transmit the request signal generated by the request signal generation unit to
the terminal apparatus, and
the terminal apparatus comprises
a terminal side data communication unit configured to execute the data communication with the server, and
a request signal reception unit configured to receive the request signal transmitted by the request signal transmission unit,
the terminal side data communication unit executing the data communication with the server on the basis of the request signal received by the request signal reception unit.

2. The communication system according to claim 1, comprising
a plurality of the terminal apparatuses, wherein
the server comprises a terminal selection unit configured to select the terminal apparatus to be a transmission destination of the request signal among the plurality of terminal apparatuses, and
the request signal transmission unit transmits the request signal to the terminal apparatus selected by the terminal selection unit.

3. The communication system according to claim 2, wherein
the server comprises a priority setting unit configured to set a propriety of each of the plurality of terminal apparatuses, and
the terminal selection unit selects the terminal apparatus to be a transmission destination of the request signal among the plurality of terminal apparatuses on the basis of the priority set by the priority setting unit.

4. The communication system according to claim 1, wherein the terminal side data communication unit executes the data communication with the server at a predetermined cycle.

5. The communication system according to claim 4, wherein
the terminal apparatus comprises
a terminal side congestion degree calculation unit configured to calculate a second congestion degree of the data communication executed with the server and a determination unit configured to determine whether to continue the data communication or interrupt the data communication until the predetermined cycle on the basis of the second congestion degree calculated by the terminal side congestion degree calculation unit, and
the terminal side data communication unit executes the data communication with the server on the basis of the request signal received by the request signal reception unit and continues the data communication or interrupts the data communication until the predetermined cycle on the basis of a determination result of the determination unit.

6. The communication system according to claim 1, wherein the server side congestion degree calculation unit calculates the first congestion degree on the basis of a throughput of the data communication between the server and the terminal apparatus.

7. A communication method, wherein
when a server and a terminal apparatus execute data communication,
the server calculates a first congestion degree of the data communication executed with the terminal apparatus,
generates a request signal that is a signal for making a request of the data communication to the terminal apparatus on the basis of the calculated first congestion degree, and
transmits the generated request signal to the terminal apparatus; and
the terminal apparatus receives the request signal transmitted by the server and
the terminal apparatus executes the data communication with the server on the basis of the received request signal.

8. (canceled)

9. (canceled)

10. (canceled)
